(19) United States
(12) Patent Application Publication
(10) Pub. No.: US 2026/0126591 A1
(43) Pub. Date: May 7, 2026

(54) WAVELENGTH SELECTIVE SWITCH WITH MULTIPLE DEFLECTOR ARRAYS

(71) Applicants: O-NET TECHNOLOGIES (CANADA) INC., Kanata, Ontario (CA); O-NET TECHNOLOGIES (SHENZHEN) GROUP CO., LTD, Shenzhen, Guangdong (CN)

(72) Inventors: Chenjun FAN, Kanata (CA); Wenlu WANG, Kanata (CA); Zuowen JIANG, Kanata (CA)

(73) Assignees: O-NET TECHNOLOGIES (CANADA) INC., Kanata, Ontario (CA); O-NET TECHNOLOGIES (SHENZHEN) GROUP CO., LTD, Shenzhen, Guangdong (CN)

(21) Appl. No.: 19/117,423

(22) PCT Filed: Sep. 1, 2023
(86) PCT No.: PCT/IB2023/058678

§ 371 Date: Apr. 1, 2025

Related U.S. Application Data
(60) Provisional application No. 63/380,827, filed on Oct. 25, 2022.

(51) Int. Cl. G02B 6/35

(52) U.S. Cl. CPC G02B 6/3588; G02B 6/3528; G02B 6/3534

(57) ABSTRACT

A wavelength selective switch includes a waveguide array for providing an input light beam, a polarizing collimator for splitting the input light beam into polarized collimated first and second sub-beams propagating along non-overlapping optical paths, and a dispersive element for angularly dispersing the first and second sub-beams into wavelength components. First and second angle-to-offset elements are provided for focusing the wavelength components of the first and second sub-beams. A first deflector array and a second, different deflector array are disposed at focal planes of the first and second angle-to-offset elements respectively for redirecting the wavelength components to propagate back through the optical train for in-coupling into a waveguide of the waveguide array. Such a configuration of the wavelength selective switch allows the use of inexpensive standard deflector arrays.

### REFERENCE TO RELATED APPLICATION

This application claims priority from U.S. Provisional Patent Application No. 63/380,827, filed on Oct. 25, 2022, entitled “Wavelength Selective Switch with Multiple Deflector Arrays”, and incorporated herein by reference in its entirety.

### TECHNICAL FIELD

The present disclosure relates to optical switching devices, and in particular to wavelength selective optical switches.

### BACKGROUND

Wavelength selective switches are types of optical switches that can redirect light between input and output port(s) in a wavelength-selective manner. A light signal propagating in an optical network is independently modulated at a plurality of wavelengths, forming so-called wavelength channels. The wavelength channels are spaced apart from one another by fixed or flexible optical frequency spacings known as ITU (International Telecommunications Union) grid, typically evenly spaced at 37.5 GHz, 50 GHz, 75 GHz, 100 GHz, 200 GHz etc. in an infrared wavelength range of between approximately 1.3 micrometers and 1.6 micrometers.

Some wavelength selective switches are capable of independently switching individual wavelength channels or entire wavelength bands between different optical fibers in an optical network. The optical network may include multiple optical fibers linking different nodes in a same city or town (metro optical networks), in different cities of a same country, and even nodes disposed in different countries or on different continents (long-haul optical networks).

While being highly functional and versatile, wavelength selective switches often include a multitude of customized free-space and/or waveguiding optical and electro-optical components. Some of the components may need to be aligned to one another with sub-micrometer precision, which drives up manufacturing costs of these devices. Furthermore, wavelength selective switches need to be compact and environmentally stable, which further complicates their design and assembly. It would be advantageous to provide an inexpensive wavelength selective switch suitable for low-cost mass production.

### BRIEF DESCRIPTION OF THE DRAWINGS

Exemplary embodiments will now be described in conjunction with the drawings, in which:

FIG. 1A is a schematic top view of a wavelength selective switch of this disclosure using two separate deflector arrays to redirect sub-beams carrying two polarization components of an input light beam;

FIG. 1B is a schematic side view of the wavelength selective switch of FIG. 1A;

FIG. 2A is an unfolded top-view optical ray diagram of an embodiment of the wavelength selective switch of FIGS. 1A and 1B, the wavelength selective switch having a reflective diffraction grating for dispersing light into wavelength components;

FIG. 2B is a side-view optical ray diagram of the wavelength selective switch of FIG. 2A, with the diffraction grating turned by 90 degrees about the optical axis, for ease of illustration;

FIG. 3 is a top-view optical ray diagram of an embodiment of the wavelength selective switch embodiment of FIGS. 2A and 2B using a complex grism with two diffraction gratings offset from one another;

FIG. 4 is a top-view optical ray diagram of an embodiment of the wavelength selective switch embodiment of FIG. 3 using a dual grism including an optically coupled pair of rhomboid-like grisms;

FIG. 5 is a magnified top view of a back end of the wavelength selective switch of FIG. 4 showing directions of alignment of in-and out-coupling prisms of the dual grism;

FIG. 6 is a magnified top view of the dual grism illustrating the back end alignment of the wavelength selective switch; and

FIG. 7 is a flow chart of a method for alignment of a wavelength selective switch of this disclosure.

### DETAILED DESCRIPTION

While the present teachings are described in conjunction with various embodiments and examples, it is not intended that the present teachings be limited to such embodiments. On the contrary, the present teachings encompass various alternatives and equivalents, as will be appreciated by those of skill in the art. All statements herein reciting principles, aspects, and embodiments of this disclosure, as well as specific examples thereof, are intended to encompass both structural and functional equivalents thereof. Additionally, it is intended that such equivalents include both currently known equivalents as well as equivalents developed in the future, i.e. any elements developed that perform the same function, regardless of structure.

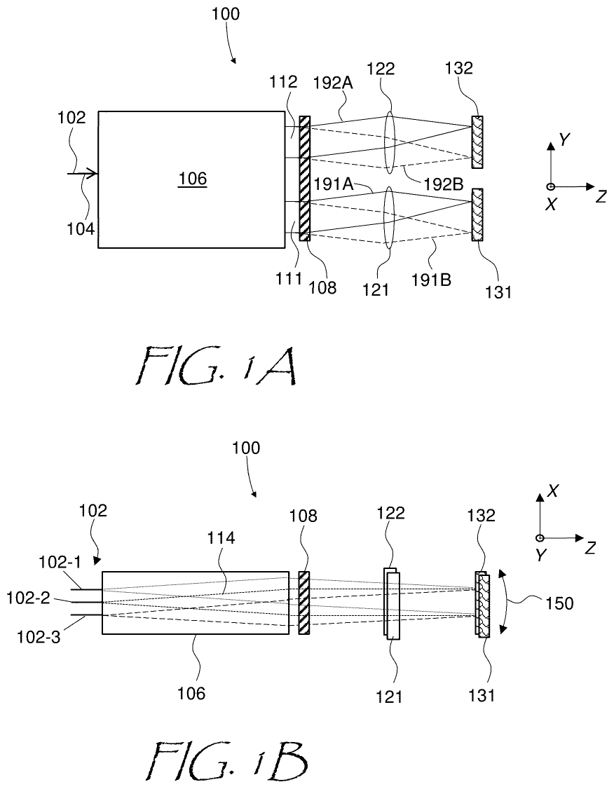

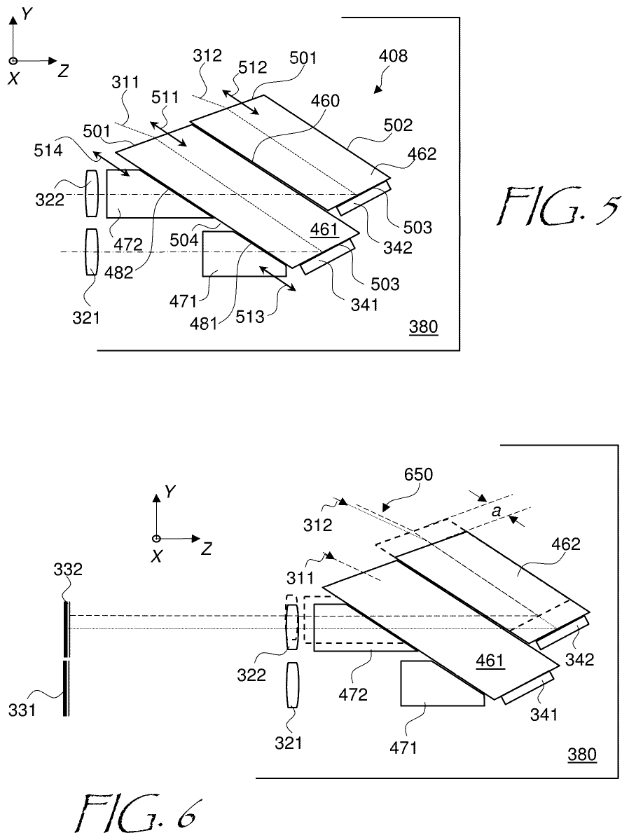

As used herein, the terms “first”, “second”, and so forth are not intended to imply sequential ordering, but rather are intended to distinguish one element from another, unless explicitly stated. Similarly, sequential ordering of method steps does not imply a sequential order of their execution, unless explicitly stated. In FIGS. 1A, B to FIG. 6, similar reference numerals denote similar elements.

The scale of manufacturing of a product is one of largest cost factors for the product. Mass-produced optical and electro-optical components are rarely manufactured to custom specifications, which hinders their use in wavelength selective switches most commonly requiring such custom specifications. This disclosure provides a configuration for a wavelength selective switch that is flexible enough to use mass-produced optical/electro-optical elements, components and sub-assemblies, in particular mass-produced deflector arrays usable as optical switching elements for switching individual wavelength channels and configurable wavelength bands between several optical ports or fibers. The wavelength selective switch may operate in a broad wavelength range beyond C band, e.g. in a 6 THz wide range.

In accordance with the present disclosure, there is provided a wavelength selective switch (WSS) comprising a waveguide array for providing an input light beam; a polarizing collimator coupled to the waveguide array for splitting the input light beam into polarized collimated first and second sub-beams propagating along non-overlapping optical paths; a dispersive element coupled to the polarizing collimator for angularly dispersing the first and second sub-beams into wavelength components; first and second angle-to-offset elements for focusing the wavelength components of the first and second sub-beams, respectively; and a first deflector array and a second, different deflector array. The first and second deflector arrays are disposed at focal planes of the first and second angle-to-offset elements respectively, for redirecting the wavelength components to propagate back through the first and second angle-to-offset elements respectively, the dispersive element, and the polarizing collimator for in-coupling into a waveguide of the waveguide array.

In some embodiments, the dispersive element is configured to disperse the first and second sub-beams into the wavelength components in a first plane. The first and second angle-to-offset elements may be configured to focus the wavelength components of the first and second sub-beams, respectively, in the first plane. The first and second deflector arrays may be configured to redirect the wavelength components in spaced apart planes perpendicular to the first plane. The first and second angle-to-offset elements may each comprise an acylindrical lens having a non-zero optical power in the first plane, and a substantially zero optical power in a plane perpendicular to the first plane. Waveguides of the waveguide array may be disposed in a plane perpendicular to the first plane.

The polarizing collimator may include a birefringent element such as e.g. a birefringent wedge or prism, optically coupled to each waveguide of the waveguide array, for angularly separating the first and second sub-beams in the first plane. The polarizing collimator may further include a rotationally symmetric lens having a first focal length and disposed substantially one first focal length downstream of the birefringent element, for collimating the first and second sub-beams to propagate parallel to one another. The WSS may further include a polarization rotator in an optical path of at least one of the first or second sub-beams upstream of the dispersive element, for converting a polarization state of at least one of the first or second sub-beams such that the first and second sub-beams have a substantially same polarization state. In some embodiments, the WSS further includes a prismatic beam expander for expanding the first and second sub-beams in the first plane. The prismatic beam expander may be disposed in an optical path of the first and second sub-beams between the polarizing collimator and the dispersive element.

In some embodiments, the dispersive element comprises first and second diffraction gratings for dispersing the first and second sub-beams, respectively, into the wavelength components. The first and second diffraction gratings may be disposed in different planes separated by a non-zero distance between them. In some embodiments, the dispersive element further comprises first and second in-coupling prisms coupled to the first and second diffraction gratings respectively, for receiving the first and second sub-beams respectively, and for coupling the first and second sub-beams to the first and second diffraction gratings respectively. The first and second in-coupling prisms may be disposed parallel one another and optically joined by an interface layer between them, the interface layer extending along parallel paths of propagation of the first and second sub-beams in the first and second in-coupling prisms respectively. During alignment of the WSS, a relative position of the first and second in-coupling prisms along the paths of propagation may be adjusted by sliding at least one of the first or second in-coupling prism along the interface layer. An optical path of the wavelength components of the second sub-beam dispersed by the second diffraction grating may include in sequence the second in-coupling prism, the interface layer, and the first in-coupling prism.

In accordance with the present disclosure, there is provided a dual grism comprising first and second in-coupling prisms for receiving and propagating therein first and second spaced apart sub-beams, respectively, of a light beam, and first and second diffraction gratings coupled to the first and second in-coupling prisms respectively, for dispersing the first and second sub-beams respectively into first and second wavelength components respectively. The first and second diffraction gratings are disposed in different planes separated by a non-zero distance between them. The first and second in-coupling prisms are disposed parallel one another and optically joined by an interface layer between them. The interface layer extends along parallel paths of propagation of the first and second sub-beams in the first and second in-coupling prisms respectively.

During alignment of the dual grism, a relative position of the first and second in-coupling prisms along the parallel paths of propagation may be adjusted by sliding at least one of the first or second in-coupling prism along the interface layer. In some embodiments, an optical path of the second wavelength components comprises in sequence the second in-coupling prism, the interface layer, and the first in-coupling prism. During alignment of the second in-coupling prism by sliding the second in-coupling prism along the interface layer, the optical path of the first wavelength components substantially does not change, i.e. does not lead to an observable change in an optical insertion loss.

The dual grism may further include a first out-coupling prism optically joined to the first in-coupling prism via a first layer between them, for out-coupling the first wavelength components from the first in-coupling prism, such that during alignment of the dual grism, a position of the first out-coupling prism may be adjusted by sliding the first out-coupling prism along the first layer, for adjusting an optical path length of the first wavelength components without adjusting an optical path length of the second wavelength components. The dual grism may further include a second out-coupling prism optically joined to the first in-coupling prism via a second layer between them, for out-coupling the second wavelength components from the first in-coupling prism, such that during alignment of the dual grism, a position of the second out-coupling prism may be adjusted by sliding the second out-coupling prism along the second layer, for adjusting an optical path length of the second wavelength components without adjusting an optical path length of the first wavelength components.

In some embodiments, the first and second in-coupling prisms each comprise first to fourth conterminous faces. The second face of the first in-coupling prism may be coupled to the fourth face of the second in-coupling prism via the interface layer. The first and second sub-beams may be received at the first faces of the first and second in-coupling prisms respectively. The first and second diffraction gratings may be coupled to the third faces of the first and second in-coupling prisms respectively.

In accordance with the present disclosure, there is further provided a method for aligning a WSS comprising a polarizing collimator for splitting an input light beam into polarized collimated first and second sub-beams. The method comprises aligning the polarizing collimator to provide the first and second sub-beams propagating along non-overlapping optical paths; aligning a first portion of a dispersive element for dispersing the first sub-beam into first wavelength components impinging onto a first angle-to-offset element independently of alignment of the second sub-beam, for the first angle-to-offset element to focus the first wavelength components onto a first deflector array; and aligning a second, different portion of the dispersive element for dispersing the second sub-beam into second wavelength components impinging onto a second angle-to-offset element independently of alignment of the first sub-beam, for the second angle-to-offset element to focus the second wavelength components onto a second, separate deflector array.

In embodiments where the first and second portions of the dispersive element comprise first and second in-coupling prisms respectively for in-coupling the first and second sub-beams respectively, where the first and second in-coupling prisms are optically coupled to one another by an interface between them, the aligning of the first portion of the dispersive element may include aligning the first portion relative to the first angle-to-offset element. The aligning of the second portion of the dispersive element may include sliding the second in-coupling prism relative to the first in-coupling prism along the interface. In operation, the second wavelength components propagate in sequence through the second in-coupling prism, the interface, and the first in-coupling prism.

In embodiments where the first and second portions of the dispersive element comprise first and second out-coupling prisms respectively for out-coupling the first and second wavelength components, respectively, from the dispersive element, where the first and second out-coupling prisms are optically coupled to the first in-coupling prism via first and second layers between them, respectively, the aligning of the second portion of the dispersive element may further comprise aligning the second out-coupling prism by sliding the second out-coupling prism along the second layer, for adjusting an optical path length of the second wavelength components independently of an optical path length of the first wavelength components.

Referring now to FIGS. 1A and 1B, a WSS 100 of this disclosure includes a waveguide array 102, e.g. a linear fiber array, for providing an input light beam 104 propagating in any of waveguides and/or fibers 102-1, 102-2, and/or 102-3 of the waveguide array 102, which is disposed in XZ plane of FIG. 1B. More waveguides/fibers may be provided as needed. A polarizing collimator 106 is coupled to the waveguide array 102 for splitting the input light beam 104 into orthogonally polarized collimated first 111 and second 112 sub-beams, which may be brought to a same polarization state at the output of the polarizing collimator 106 for subsequent propagation through the WSS 100 along non-overlapping optical paths having a balanced optical throughput and path length. In other words, the collimated first 111 and second 112 sub-beams correspond to orthogonally polarized components of the input light beam 104, which may be brought to a same polarization state for the purpose of reduction of polarization-dependent optical loss (PDL). For example, the collimated first 111 and second 112 sub-beams may be brought to a linear polarization of a same angle of polarization (e.g. horizontal or vertical) for subsequent propagation through the WSS 100 along the non-overlapping optical paths, as illustrated in FIG. 1A.

A dispersive element 108, such as a diffraction grating, is coupled to the polarizing collimator 106 for angularly dispersing each one of the first 111 and second 112 sub-beams into wavelength components or individual wavelength channels. In FIG. 1A, the dispersive element 108 disperses the first sub-beam 111 into a plurality, or more generally a continuum, of wavelength components between a longest-wavelength component 191A shown with solid lines, and a shortest-wavelength component 191B shown with dashed lines. Similarly, the dispersive element 108 disperses the second sub-beam 112 into a plurality/continuum of wavelength components between a longest-wavelength component 192A shown with solid lines, and a shortest-wavelength component 192B shown with dashed lines. The wavelength components of the first 111 and second 112 sub-beams are angularly dispersed in YZ plane of FIG. 1A.

First 121 and second 122 angle-to-offset elements are coupled to the dispersive element 108, and are configured to focus the wavelength components 191A-B and 192A-B of the first 111 and second 112 sub-beams, respectively, in YZ plane of FIG. 1A, while optionally having zero optical power, i.e. zero focusing/defocusing power, in XZ plane of FIG. 1B. In other words, the first 121 and second 122 angle-to-offset elements have a non-zero optical power in YZ plane while having a substantially zero optical power in XZ plane. By way of a non-limiting example, cylindrical and/or acylindrical lenses may be used as the first and second 122 angle-to-offset elements. Herein, the term “acylindrical lens” means a lens that has an optical power only in one plane, and has a surface profile deviating from a cylindrical surface profile. The purpose of the angle-to-offset elements 121, 122 is to convert the beam angle of wavelength-dispersed wavelength components into a beam coordinate at focal planes of the angle-to-offset elements 121, 122 in YZ plane i.e. the plane of FIG. 1A, while keeping the propagation of the wavelength-dispersed wavelength components in the XZ plane, i.e. the plane of FIG. 1B, largely unaffected. The dispersive element 108 may be disposed at front focal planes of the angle-to-offset elements 121, 122.

A first deflector array 131 and a second, different deflector array 132 are disposed at back focal planes of the first 121 and second 122 angle-to-offset elements respectively. The purpose of the first 131 and second 132 deflector arrays is to redirect the wavelength components at a variable angle represented by an arrow 150 (FIG. 1B) to propagate back through the first 121 and second 122 angle-to-offset elements respectively, the dispersive element 108, and the polarizing collimator 106 for recombination and in-coupling into a desired waveguide of the waveguide array 102, e.g. into any of the waveguides 102-1, 102-2, or 102-3 of the waveguide array 102, as depicted by dashed and dotted lines 114 in FIG. 1B. The WSS 100 may be configured to send the redirected light back into the input waveguide, in which case the input waveguide may be equipped with an optical circulator to separate the input and output light beams. Alternatively, the WSS 100 may be configured to not send the redirected light back into the input waveguide. The direction of propagation of light in the WSS 100 may be reversed, so that the 1xN WSS 100 may also operate as an Nx1 WSS.

Herein and throughout the rest of the application, the term “different deflector array” means another copy of a deflector array, e.g. in a different (i.e. not the same item) package, although the two arrays may be of a same type, shape, and function, and may be coupled to a same mechanical supporting structure and/or disposed within a same body of the WSS. The first 131 and second 132 deflector arrays may be disposed at the back focal plane of the polarizing collimator 106, and may be configured to redirect the wavelength components in spaced apart planes parallel to XZ plane (i.e. up and down as illustrated in FIG. 1B) and perpendicular to YZ plane. The first 131 and second 132 deflector arrays may include, for example, reflective liquid crystal arrays such as Liquid Crystal on Silicon (LCoS) arrays, microelectromechanical system (MEMS) tiltable reflector arrays, etc. The first 131 and second 132 deflector arrays may be disposed in a same plane, or alternatively they may be shifted relative to each other by up to approximately 10% of a focal length of the polarizing collimator 106 along the light propagation path, e.g. to provide a more compact overall configuration. The resulting difference in optical loss may be compensated by providing a corresponding driving offset of the first 131 and/or second 132 deflector arrays. The optical loss, also termed insertion loss, results from an angular misalignment at the output waveguide(s) caused by the focal length mismatch. By way of example, at the 10% focal length mismatch, the extra loss due to angular misalignment may be approximately 0.2 dB. The first 131 and second 132 deflector arrays may be driven to flatten out the 0.2 dB extra loss across all wavelength spectrum.

Using two physically separate (i.e. separate copies of) deflector arrays 131, 132 for wavelength channels of different sub-beams provides one with a greater degree of flexibility of selecting required wavelength dispersion, resolution, and/or the number of wavelength channels for the WSS 100, as compared to a case when a single large array is used to redirect wavelength components of both sub-beams. Due to geometrical constraints, the focused wavelength components 191A-B and 192A-B of the sub-beams 111, 112 often need to be sufficiently spatially separated from each other, resulting in only a partial use of the large array with a significant number of unused deflector pixels. In contradistinction, relying instead on a pair of physically separated, smaller deflector arrays allows one to tailor the optical configuration of the WSS 100 to off-the-shelf deflector arrays available at low cost. With two deflector arrays 131, 132 instead of one large array, both the number of unused pixels and the manufacturing costs of the WSS 100 may be significantly reduced.

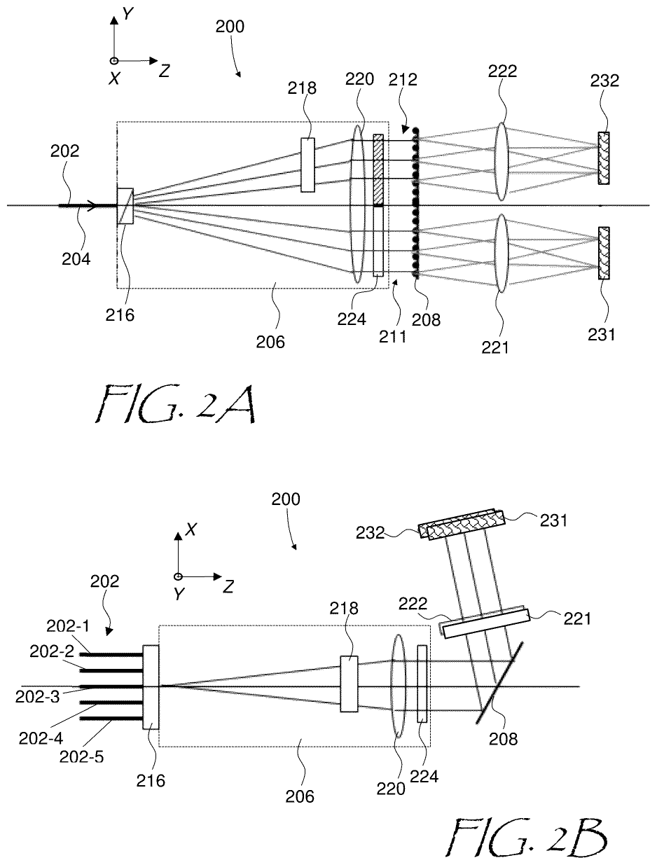

Turning to FIGS. 2A and 2B, a WSS 200 is an embodiment of the WSS 100 of FIGS. 1A and 1B, and includes similar elements. The WSS 200 of FIGS. 2A and 2B includes a waveguide array 202 e.g. a linear fiber array, having five waveguides 202-1, 202-2, 202-3, 202-4, and 202-5 disposed in XZ plane of FIG. 2B. An input light beam 204 may be coupled into any of the waveguides 202-1 . . . 202-5 of the waveguide array 202. A waveguide of the waveguide array 202, e.g. the center waveguide 202-3 as depicted in FIG. 2B, may be used to inject the input light beam 204 into a polarizing collimator 206. An optional lens array, or a microlens array, may be coupled to the waveguide array 202 for providing light beams with required waist sizes and far-field divergence.

The polarizing collimator 206 is coupled to the waveguide array 202 for splitting the input light beam 204 into orthogonally polarized first 211 and second 212 sub-beams. The first 211 and second 212 sub-beams may be collimated and brought to a same polarization state for subsequent propagation through the rest of the WSS 200 along non-overlapping optical paths. The polarizing collimator 206 may include a birefringent element 216, e.g. a Wollaston prism or a wedge of a birefringent material, to angularly separate the first 211 and second 212 sub-beams in YZ plane. The birefringent element 216 is coupled to a rotationally symmetric collimating lens 220, e.g. a spherical lens, an aspherical lens, a compound lens, etc., disposed substantially (i.e. within 10%) one focal length of the collimating lens 220 away from the tips of the waveguide array 202, to collimate the first 211 and second 212 sub-beams, which propagate parallel to one another along separate optical paths, as shown in FIG. 2A. An optional compensator plate 218 may be disposed in an optical path of one of the first 211 and second 212 sub-beams for compensating an optical path length misbalance caused by the birefringent element 216.

A polarization rotator 224 may be disposed in an optical path downstream of the collimating lens 220 with respect to the optical paths of the first 211 and/or second 212 sub-beams. The polarization rotator 224 may optionally be disposed upstream of the collimating lens 220. The polarization rotator 224 brings one of the first 211 and second 212 sub-beams to a polarization state of the other one of first 211 and second 212 sub-beams, making them nearly identically polarized. To that end, the polarization rotator 224 may include a combination of a glass plate, shown as a white rectangle in FIG. 2A, and a half-wave plate, shown as a dashed rectangle in FIG. 2A.

A reflective diffraction grating 208 is coupled to the polarizing collimator 206 for angularly dispersing the first 211 and second 212 sub-beams into wavelength components, e.g. individual wavelength channels. It is to be noted that in FIG. 2A, the optical path downstream of the reflective diffraction grating 208 is unfolded for clarity, while in FIG. 2B, the reflection of the diffracted light from the reflective diffraction grating 208 is explicitly illustrated. The reflective diffraction grating 208 and the optical path of the diffracted first 211 and second 212 sub-beams are shown in FIG. 2B rotated by 90 degrees about Z axis from their nominal orientation, for illustration purposes. A grism, i.e. a grating coupled to a prism, may be used in place of the reflective diffraction grating 208.

First 221 and second 222 cylindrical or acylindrical lenses may be optically coupled to the reflective diffraction grating 208 for focusing the wavelength components of the first 211 and second 212 sub-beams, respectively, at spaced apart locations in YZ plane while having zero optical power, i.e. zero focusing/defocusing power, in XZ plane. The propagation of the wavelength-dispersed wavelength components in the XZ plane may be largely unaffected. The purpose of the first 221 and second 222 lenses is to convert the beam angle of the wavelength-dispersed wavelength components into a beam coordinate in focal planes of the first 221 and second 222 lenses. The first 221 and second 222 lenses are termed herein “angle-to-offset”, or “Fourier” elements or lenses. The reflective diffraction grating 208 may be disposed at the front focal plane of the first 221 and second 222 lenses.

A first deflector array 231 and a second, different, spaced apart deflector array 232 are disposed at focal planes of the first 221 and second 222 lenses respectively for redirecting the wavelength components at a variable angle to propagate back through the first 221 and second 222 lenses respectively, the reflective diffraction grating 208, and the polarizing collimator 206 for recombination and in-coupling into a waveguide of the waveguide array 202, e.g. into any of the waveguides 202-1 . . . 202-5 of the waveguide array 202. The first 231 and second 232 deflector arrays may include, for example, reflective liquid crystal arrays such as LCOS arrays, MEMS tiltable mirror arrays, etc. Using physically separate (i.e. separate copies of) deflector arrays for different sub-beams provides a greater flexibility of selecting required wavelength dispersion and resolution, the number of wavelength channels, etc. for the WSS 200, allowing one to use mass-produced inexpensive deflector arrays. The first 231 and second 232 deflector arrays are configured to redirect the wavelength components at a variable angle in the XZ plane of FIG. 2B.

The first 231 and second 232 deflector arrays may be disposed at about one focal length of the collimating lens 220 away from the collimating lens 220. The waveguide array 202 may be disposed about one focal length of the collimating lens 220 away from the collimating lens 220, causing the collimating lens 220 to operate as an angle-to-offset element converting a beam angle of the redirected wavelength components at the first 231 and second 232 deflector arrays into a beam coordinate at the waveguide array 202, which enables the wavelength selective switching of the wavelength components between the waveguides 202-1 . . . 202-5 of the waveguide array 202 with a minimum coupling loss. The first 231 and second 232 deflector arrays may be off-focus by up to 10-15% of the focal length of the collimating lens 220. It is to be understood that the direction of propagation of light in the WSS 200 may be reversed, so that the 1xN WSS 200 may operate as an Nx1 WSS.

The configuration of the WSS 200 of FIGS. 2A and 2B is termed herein a “2f” configuration, since the collimating lens 220 is disposed approximately one focal length (“1f”) of the collimating lens 220 away from the waveguide array 202, and the first 231 and second 232 deflector arrays are disposed approximately one focal length (“1f”) of the collimating lens 220 away from the collimating lens 220. Furthermore, the first 221 and second 222 lenses are disposed one focal length of these lenses 221, 222 away from the reflective diffraction grating 208, and the first 231 and second 232 deflector arrays are disposed one focal length of the lenses 221, 222 away from them. For this reason, the configuration of the WSS 200 may also be described as a “nested 2f” configuration where the focal length of the first 221 and second 222 lenses is approximately equal to one half of the focal length of the collimating lens 220. It is to be noted that the 2:1 ratio between the focal lengths of the collimating lens 220 on one hand, and the first 221 and second 222 lenses on the other, does not need to be followed strictly; in some embodiments, the ratio may be as large as 4:1.

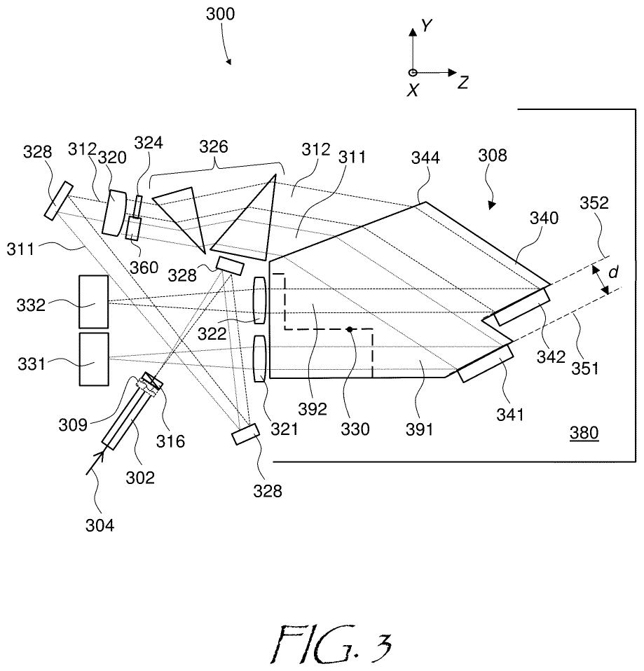

Referring now to FIG. 3, a WSS 300 is an embodiment of the WSS 200 of FIGS. 2A and 2B and the WSS 100 of FIGS. 1A and 1B, and includes similar elements. The WSS 300 of FIG. 3 includes a waveguide array 302, e.g. a linear fiber array, for injecting an input light beam 304 into the WSS 300, and for wavelength selective outputting the light beam 304 into any of the waveguide(s) of the waveguide array 302. An optional lens array, or microlens array 309 may be coupled to the waveguide array 302 for providing required optical beam waist sizes/divergence. It is to be understood that, just like in case of the wavelength selective switches 100 of FIGS. 1A-1B and 200 of FIGS. 2A-2B, the direction of propagation of light may be reversed, so that 1xN WSS may operate as an Nx1 WSS.

A polarizing collimator of the WSS 300 includes a birefringent element 316 optically coupled to a collimating lens 320 by means of three folding mirrors 328, which are flat mirrors but may be curved in some embodiments. The birefringent element 316 splits the light beam 304 into first 311 and second 312 sub-beams in YZ plane. The optical path of the first sub-beam 311 is shown with dotted lines, and the optical path of the second sub-beam 312 is shown with dashed lines. Upstream of the collimating lens 320, the optical paths are represented by chief rays only, for brevity, and downstream of the collimating lens 320, the optical paths are represented by two boundary rays. The optical paths of the first 311 and second 312 sub-beams between the collimating lens 320 and respective diffraction gratings 341, 342 are parallel to one another and not overlapping with one another, i.e. physically separate from one another.

A polarization rotator 324 may be disposed in an optical path of the second sub-beam 312 to bring the polarization state of the second sub-beam 312 to that of the first sub-beam 311, making them nearly identically polarized. By way of a non-limiting illustrative example, the polarization rotator 324 may include a half-wave plate with an optic axis oriented at 45 degrees to a polarization direction of the linearly polarized first sub-beam 311. The polarization rotator 324 may be disposed in the optical path of the second sub-beam 212, and may be disposed downstream or upstream of the collimating lens 320.

The WSS 300 may further include a prismatic beam expander 326 having a set of several (in this case two) prisms configured to expand the first 311 and second 312 sub-beams in YZ plane for improvement of spectral resolution.

The prism may be right-angle, acute-angle, or obtuse-angle prisms, as long as the parallelism of the first 311 and second 312 sub-beams is preserved. The prisms of the prismatic beam expander 326, as well as other elements of the WSS 300, may be anti-reflection (AR) coated to reduce optical losses and ghosting, i.e. ghost reflections. Tilted surfaces of both prisms of the prismatic beam expander 326 may be disposed at a Brewster angle for reduction of Fresnel reflections of the first 311 and second 312 sub-beams, which may be polarized in YZ plane to take advantage of Brewster angle reflection suppression. The prisms of the prismatic beam expander 326 may be disposed in an optical path of the first 311 and second 312 sub-beams between the polarization rotator 324 of the polarizing collimator and a dispersive element, in this example a grism 308.

The purpose of the grism 308 is to angularly disperse the first 311 and second 312 sub-beams into wavelength components/wavelength channels. Only one such wavelength component is shown for each sub-beam for brevity: a first wavelength component 391 of the first sub-beam 311, and a second wavelength component 392 of the second sub-beam 312. In the embodiment shown in FIG. 3, the grism 308 includes a complex prism 340 optically coupled to first 341 and second 342 offset reflective diffraction gratings. The first 341 and second 342 reflective diffraction gratings are disposed in first 351 and second 352 different planes, respectively, for receiving the first 311 and second 312 sub-beams respectively. Herein, the term “disposed in different planes” means that the first 351 and second 352 planes are separated by a non-zero distance d, as illustrated in FIG. 3. The first 351 and second 352 planes may be parallel or non-parallel to each other.

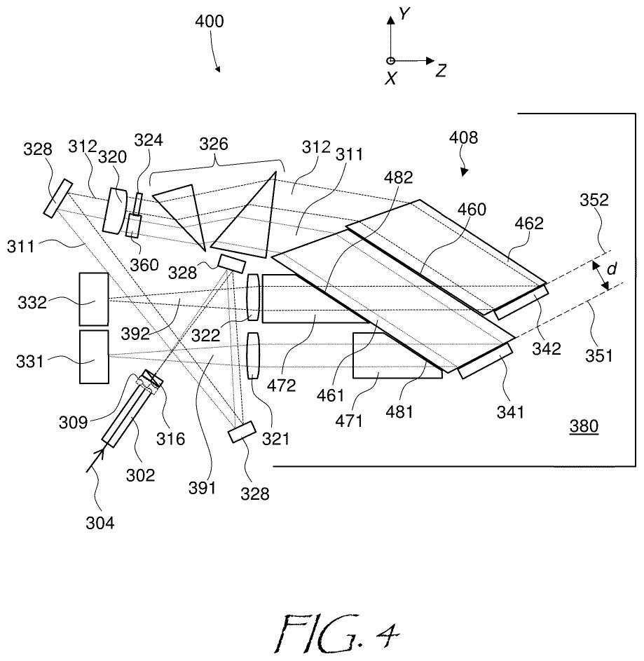

The first 341 and second 342 reflective diffraction gratings are optically coupled to the complex prism 340, which may include a common facet 344 for receiving the first 311 and second 312 sub-beams, and/or a cutout shown in dashed lines 330, for balancing optical path lengths of the first 311 and second 312 sub-beams. The common facet 344 may be replaced with two offset separate facets, to intercept the first 311 and second 312 sub-beams at different planes, i.e. at planes offset w.r.t. the optical path of propagation of the first 311 and second 312 sub-beams. The common facet 344 or two separate facets may be disposed at a Brewster angle for reduction of unwanted Fresnel reflections from the facet(s). In some embodiments, the complex prism 340 may include a pair of prisms of a simpler shape, forming a pair of grisms when coupled with the respective first 341 and second 342 reflective diffraction gratings. The prisms of the pair of prisms may be index-matched to one another. One example of such a configuration is discussed further below with reference to FIG. 4.

Still referring to FIG. 3, a compensating element 360 may be provided in an optical path of the first sub-beam 311 between the collimating lens 320 and the grism 308 for further balancing the optical path lengths of the two different polarization components/sub-beams 311 and 312, to reduce or eliminate a polarization mode dispersion (PMD) of the WSS 300. In some embodiments, the compensating element 360, or an additional compensating element, may be provided in an optical path of the second sub-beam 312. The compensating element 360 may be placed anywhere in the optical path of the first 311 and/or second 312 sub-beam(s), and may be used for reduction of polarization mode dispersion (PMD) of the WSS 300. The compensating element 360 may have high refractive index for compactness. For example, in some embodiments, the compensating element 360 may be made out of an optical-grade silicon, which is transparent at telecommunication wavelengths.

The WSS 300 may further include first 321 and second 322 cylindrical or acylindrical lenses for focusing the wavelength components of the first 311 and second 312 sub-beams onto first 331 and second 332 deflector arrays, respectively, in YZ plane, while having substantially zero optical power (i.e. focusing/defocusing power) in XZ plane. The first 331 and second 332 deflector arrays are configured to redirect the dispersed wavelength components of the first 311 and second 312 sub-beams, respectively, to propagate back through the first 321 and second 322 lenses, the grism 308, and further retracing the optical path backward, towards the waveguide array 302. The first 331 and second 332 deflector arrays may be separate units of deflector arrays disposed on a common supporting plate, e.g. separate LCOS arrays on a common ceramic mount for ease of alignment and thermal control. The first 331 and second 332 deflector arrays redirect the optical components in planes perpendicular to the YZ plane, e.g. in planes parallel to XZ plane.

At least some of the optical components of the WSS 300 may be supported by a base 380, which is shown only partially in FIG. 3 for brevity. The base 380 may be transparent or opaque, and/or may have openings for the wavelength components 391 and 392 redirected by optional turning mirrors or prisms to propagate through the base 380. By way of non-limiting examples, the base 380 may made out of a material with a high thermal conductivity such as aluminum nitride (AlN), or an insulator such as fused silica (SiO₂). The first 331 and second 332 deflector arrays may be mechanically coupled to the base 380 at the top or bottom of the base 380.

Using two separate LCOS arrays to redirect different polarization components or sub-beams may be more beneficial than having to rely on a large single array. For a very fine spacing 6.25 GHz flex-grid WSS applications, one needs to use smaller pixel size. Otherwise, one would need to use a longer focal length for the first 321 and second 322 cylindrical lenses, which is undesirable, because the footprint of the WSS 300 may become too long. A larger LCOS panel of finer pixel size is more expensive than a proportion of its size suggests, while using two smaller LCOS panels enables one to use relatively small standard LCOS panels that are inexpensive due to mass production of such panels.

The grism-based configuration of the WSS 300 provides ergonomic and space-efficient positioning of various elements of the WSS 300. The deviation angle of the birefringent element 316 may be reduced to lessen optical aberrations. The grism-based configuration of the WSS 300 further allows one to increase a center-to-center distance of the first 331 and second 332 deflector arrays, which allows a broader choice of mass-produced deflector arrays. The geometrical shape and size of the complex prism 340 may be selected to accommodate a required spacing between the deflector arrays 331, 332.

Turning now to FIG. 4, a WSS 400 is an embodiment of the WSS 300 of FIG. 3, and includes similar elements. The WSS 400 of FIG. 4 includes a dual grism 408 in place of the single grism 308 of the WSS 300 of FIG. 3. The dual grism 408 of FIG. 4 performs a similar function of angularly dispersing each one of the first 311 and second 312 sub-beams propagating along separate, i.e. non-overlapping, optical paths, into individual wavelength components. Specifically, the first sub-beam 311 is angularly dispersed into the first wavelength components 391 (only one is shown for brevity), and the second sub-beam 312 is angularly dispersed into the second wavelength components 392 (only one is shown). One advantage of the dual grism 408 of FIG. 4 over the grism 308 of FIG. 3 is that the shape of the dual grism 408 of FIG. 4 may be adjusted during alignment of the WSS 400 to accommodate manufacturing tolerances of various upstream and downstream optical elements of the WSS 400, allowing the use of cheaper parts with looser geometrical tolerances, substantially without impact on the achievable performance.

In the embodiment shown, the dual grism 408 includes first 461 and second 462 in-coupling prisms for receiving and propagating within the prisms the first 311 and second 312 spaced apart sub-beams, respectively, of the light beam 304. The first 341 and second 342 diffraction gratings are coupled to the first 461 and second 462 in-coupling prisms respectively for dispersing the first 311 and second 312 sub-beams respectively into first 391 and second 392 wavelength components respectively. The first 341 and second 342 diffraction gratings are disposed in different planes 351, 352 separated by the non-zero distance d between them, similar to FIG. 3. The first 461 and second 462 in-coupling prisms (FIG. 4) are disposed parallel one another and optically joined by an interface layer 460 between them, e.g. by a layer of a transparent curable epoxy, allowing one to adjust the shape of the grism 408 by sliding the first 461 and/or second 462 in-coupling prisms relative to one another on the base 380 before curing the epoxy. The interface layer 460 extends along parallel paths of propagation of the first 311 and second 312 sub-beams in the first 461 and second 462 in-coupling prisms respectively.

A first out-coupling prism 471 may be optically joined to the first in-coupling prism 461 via a first layer 481 between them, e.g. a layer of a transparent curable epoxy, for out-coupling the first wavelength components 391 from the first in-coupling prism 461. The optical path of the first wavelength components 391 includes in sequence the first in-coupling prism 461, the first diffraction grating 341, the first layer 481, and the first out-coupling prism 471, as illustrated. The optical path of the first wavelength components 391 may be adjusted without changing the optical path of the second wavelength components 392 by sliding the first out-coupling prism 471 along the first layer 481, if required.

A second out-coupling prism 472 may be optically joined to the first in-coupling prism 461 via a second layer 482 between them, e.g. a layer of a transparent curable epoxy, for out-coupling the second wavelength components 392 from the first in-coupling prism 461. The optical path of the second wavelength components 392 includes in sequence the second in-coupling prism 462, the second diffraction grating 342, the interface layer 460, the first in-coupling prism 461, the second layer 482, and the second out-coupling prism 472. The optical path length of the second wavelength components 392 may be adjusted without changing the optical path length of the first wavelength components 391 by sliding the second out-coupling prism 472 along the second layer 482.

The process of alignment of the dual grism 408 is further illustrated in the plan views of FIGS. 5 and 6. FIG. 5 shows sliding directions 511-514 of all prisms of the dual grism 408 on the base 380. Alternatively, at least some of the prisms may be slid on a removable spacer layer placed onto the base 380, and the spacer may be removed after alignment is complete. The sliding directions 511-514 are all parallel to the plane of FIG. 5. In the embodiment shown in FIG. 5, the first 461 and second 462 in-coupling prisms of the dual grism 408 each have has first 501 to fourth 504 conterminous faces seen in FIG. 5 as straight lines. The first 501 and third 503 faces of both prisms may, but do not have to, be parallel to each other, and the second 502 and fourth 504 faces of both prisms may, but do not have to, be parallel to each other. The fourth face 504 of the second in-coupling prism 462 is coupled to the second face 502 of the first in-coupling prism 461 via the interface layer 460. The first 341 and second 342 diffraction gratings are coupled to the third faces 503 of the first 461 and second 462 in-coupling prisms respectively.

During alignment, the first 311 and second 312 sub-beams are received at the first faces 501 of the first 461 and second 462 in-coupling prisms respectively. A relative position of the first 461 and second 462 in-coupling prisms along the parallel paths of propagation of the first 311 and second 312 sub-beams is adjusted by sliding at least one of the first 461 or second 462 in-coupling prisms on the base 380 along the interface layer 460. Similarly, a relative position of the first 471 and second 472 out-coupling prisms may be adjusted by sliding at least one of first 471 and second 472 out-coupling prisms along the first 481 and second 482 layers joining these prisms to the first in-coupling prism 461.

The dual grism 408 allows one to decouple the alignment of the optical paths of the first 311 and second 312 sub-beams. In other words, the alignment of the prisms in the light path of the first sub-beam 311 and its wavelength components does not impact the light path of the second sub-beam 312 and its wavelength components, and vice versa, the alignment of the prisms in the light path of the second sub-beam 312 and its wavelength components does not impact the light path of the first sub-beam 311 and its wavelength components. Such decoupling of the sub-beams 311, 312 alignment provides a greater degree of flexibility in selecting the order of alignment of the polarization sub-beam paths in the WSS 400 of FIG. 4, as well as in selecting the specific optical elements, and/or groups of such elements, to shift/rotate/reposition at different steps of the alignment process.

FIG. 6 provides a non-limiting illustrative example of the polarization sub-beam alignment process of the WSS 400. Firstly, the first diffraction grating 341 and the first out-coupling prism 471 may be coupled e.g. epoxied to the first in-coupling prism 461, and the resulting assembly is placed onto the base 380. Secondly, the assembly may be aligned as a unit on the base 380. The first lens 321 is also aligned, i.e. shifted and/or rotated, to place the entire spectrum of the wavelength components of the first sub-beam 311 onto the first deflector array 331. The angle of incidence of the wavelength components onto the first deflector array 331 in YZ plane may be adjusted by fine-tuning the position of the first lens 311 relative to the assembly. The angle misalignment in XZ plane may be compensated for by providing a corresponding driving offset to the pixels of the first deflector array 331.

Once the optical path of the first sub-beam 311 is aligned, the second diffraction grating 342 may be epoxied to the second in-coupling prism 462, and the resulting subassembly may be placed onto the base 380 such that the second in-coupling prism 462 is disposed adjacent the first in-coupling prism 461 and index-matched to the first in-coupling prism 461. The second out-coupling prism 472 may then be placed onto the base 380 adjacent the other side first in-coupling prism 461 and index-matched to the first in-coupling prism 461.

The optical path of the second sub-beam 312 may now be actively aligned by adjusting the positions of the second in-coupling prism 462, the second out-coupling prism 472, and the second lens 322. The second in-coupling prism 462, the second out-coupling prism 472, and the second lens 322 are shown in FIG. 6 in dashed lines before the adjustment, and in solid lines after the adjustment. The optical path of a chief ray of the second sub-beam 312 is shown in dashed lines before the adjustment, and in dotted lines after the adjustment. Before the adjustment, the chief ray was misaligned with the second deflector array 332. Sliding the second in-coupling prism 462 by the distance a allows one to center the chief ray. The position of the second lens 322 may be adjusted accordingly as illustrated, to center the spectrum of the wavelength components of the second sub-beam 312 on the second deflector array 332, and to align the angle of incidence in the YZ plane. The second out-coupling prism 472 may be shifted to balance the polarization mode dispersion (PMD) of the WSS 400 (FIG. 4).

The second in-coupling prism (FIG. 6; 462) and the second lens 322 may be shifted to compensate for angle tolerances in the birefringent element (FIG. 4; 316) and the prismatic beam expander 326, which jointly result in a shift of the second sub-beam 312 from to its nominal position. An error or tolerance of the distance between the first 311 and second 312 sub-beams may be precisely accommodated by sliding the second in-coupling prism (FIG. 6; 462) and the second lens 322, as evidenced by a small shift 650 of the chief ray position of the second sub-beam 312 indicated by non-overlapping dotted and dashed lines upstream of the second in-coupling prism 462.

The alignment of the first 471 and/or second 472 out-coupling prisms may be performed to precisely equate the optical path lengths of the two polarization sub-beams 311, 312. The optical path lengths of the polarization sub-beams 311, 312 have been mostly equated by the compensating element 360, which may be made out of a high-index material to reduce its length. The alignment of the first 471 and/or second 472 out-coupling prisms may serve to further reduce or completely eliminate the PMD, and/or to adjust the optical distance between the diffraction gratings 341, 342 and respective lenses 321, 322 such that the lenses 321 and 322 are disposed in a same plane parallel to XY plane. The adjustment of the optical paths in the WSS 400 of FIG. 4 is fully independent, allowing one to balance both polarization-dependent loss (PDL), as well as PMD, across the entire spectral band of operation of the WSS 400. Furthermore, using two separate deflector arrays makes it more feasible to expand into 6 THz operation wavelength range, because the two separate deflector arrays can work at relatively large aperture without introducing significant aberrations, i.e. operating in a paraxial region.

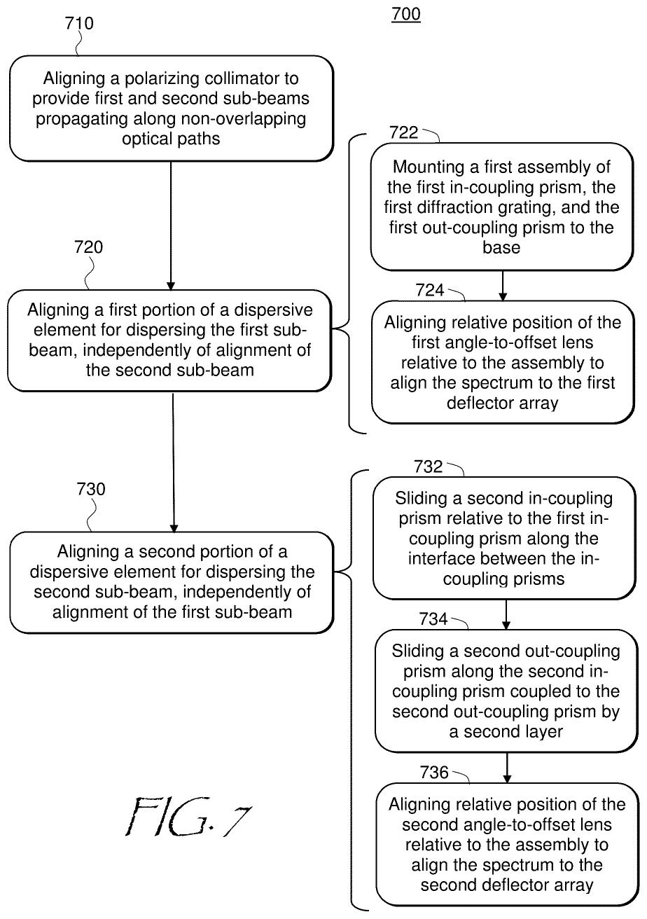

Referring now to FIG. 7 with further reference to FIGS. 4-6, a method 700 (FIG. 7) can be used to align a WSS having a polarizing collimator for splitting an input light beam into polarized collimated first and second sub-beams propagating along non-overlapping optical paths. By way of a non-limiting example, the WSS 400 of FIG. 4 has a polarizing collimator including the folding mirrors 328, the collimating lens 320, and the polarization rotator 324 (FIG. 4).

The polarizing collimator is aligned (FIG. 7; 710) to provide the first and second sub-beams propagating along non-overlapping optical paths. During the alignment of the polarizing collimator, the angle and position of the waveguide array 302, the folding mirrors 328, and the collimating lens 320 (FIG. 4) may be adjusted to route the first 311 and second 312 polarized sub-beams for propagation along pre-determined non-overlapping optical paths. The optical path may be built element-by-element, going from an upstream element to a downstream element. For example, the optical path may be built by first placing and aligning the waveguide array 302 for the diverging first 311 and second 312 polarized sub-beams to propagate along pre-determined marked-up paths, then placing an aligning, one by one, the folding mirrors 328 for the diverging first 311 and second 312 polarized sub-beams to propagate along pre-determined marked-up paths, then placing and aligning the collimating lens 320 for the collimated first 311 and second 312 polarized sub-beams to propagate along pre-determined paths, and so on.

A first portion of a dispersive element of the WSS is aligned (FIG. 7; 720) to angularly disperse the first sub-beam, e.g. the first sub-beam 311 in FIG. 4, into first wavelength components, e.g. the first wavelength components 391, impinging onto a first angle-to-offset element, e.g. the first lens 321, which focuses the wavelength components onto the first deflector array 331. The first portion of the dispersive element may include the first in-coupling prism 461, the first diffraction grating 341, and the first out-coupling prism 471 of the dual grism 408. The first in-coupling prism 461 may be aligned e.g. by sliding the first in-coupling prism 461 in a direction indicated by arrows 511 (FIG. 5) for the first lens 321 to focus the first wavelength components 391 onto the first deflector array 331 (FIG. 4) at a normal angle of incidence. Alternatively, the first portion of the dual grism 408 (i.e. the first in-coupling prism 461, the first diffraction grating 341, and the first out-coupling prism 471) may be passively pre-assembled and placed onto the base 380 (FIG. 7; 722), and then aligned as a unit on the base 380 together with the first lens 321 (FIG. 7; 724) to properly fit the entire spectrum of the focused wavelength components onto the first deflector array 331 at a substantially normal angle of incidence in the YZ plane.

A second, different portion of the dispersive element may be aligned (FIG. 7; 730) so as to angularly disperse the second sub-beam, e.g. the second sub-beam 312 in FIG. 4, into second wavelength components, e.g. the second wavelength components 392, impinging onto a second angle-to-offset element, e.g. the second lens 322. In this example, the second portion of the dispersive element includes the second in-coupling prism 462, the second diffraction grating 342, and the second out-coupling prism 472 of the dual grism 408. The second in-coupling prism 462 may be aligned as indicated by arrows 512 in FIG. 5 together with the second lens 322 to direct the second wavelength components 392 to fill the clear aperture of the second deflector array 331 at a nearly normal angle in YZ plane.

The alignment of the second portion of the dispersive element may include sliding (732) the second in-coupling prism 462 relative to the first in-coupling prism 461 along the interface 460, as indicated by arrows 512 in FIG. 5, to properly center the wavelength components of the second sub-beam 312 on the second deflector array 332, as illustrated in FIG. 6. The second out-coupling prism 472 optically joined to the first in-coupling prism 461 via the second layer 482 (FIG. 5) may be aligned (FIG. 7; 734) by sliding the second out-coupling prism 472 along the first in-coupling prism 461 for adjusting an optical path length of the second wavelength components independently of an optical path length of the first wavelength components. The first 471 and/or second 472 out-coupling prisms may be shifted to adjust the PMD and/or to adjust the optical distance between the respective first 341 and/or second 342 diffraction gratings, on one hand, and the respective first 321 and second 322 lenses, on the other, such that the lenses 321 and 322 are disposed in a same plane parallel to XY plane. For example, referring back to FIG. 5, the second out-coupling prism 472 may be moved in a direction indicated by arrows 514 to adjust the PMD. The position of the second lens 322 relative to the second portion of the dual grism 408 may be adjusted (FIG. 7; 736) to align the spectrum (i.e. the second wavelength components) to the second deflector array 332, as well as the angle of incidence of the second wavelength components onto the second deflector array 332. The independent alignment of the first 311 and second 312 sub-beams makes the optical path length, PDL, and PMD balancing of the WSS 400 much easier.

The present disclosure is not to be limited in scope by the specific embodiments described herein. Indeed, other various embodiments and modifications, in addition to those described herein, will be apparent to those of ordinary skill in the art from the foregoing description and accompanying drawings. Thus, such other embodiments and modifications are intended to fall within the scope of the present disclosure. Further, although the present disclosure has been described herein in the context of a particular implementation in a particular environment for a particular purpose, those of ordinary skill in the art will recognize that its usefulness is not limited thereto, and that the present disclosure may be beneficially implemented in any number of environments for any number of purposes. Accordingly, the claims set forth below should be construed in view of the full breadth of the present disclosure as described herein.

What is claimed is:

1. A wavelength selective switch (WSS) comprising:
a waveguide array for providing an input light beam;
a polarizing collimator coupled to the waveguide array for splitting the input light beam into polarized collimated first and second sub-beams propagating along non-overlapping optical paths;
a dispersive element coupled to the polarizing collimator for angularly dispersing the first and second sub-beams into wavelength components;
first and second angle-to-offset elements for focusing the wavelength components of the first and second sub-beams, respectively; and
a first deflector array and a second, different deflector array, disposed at focal planes of the first and second angle-to-offset elements respectively, for redirecting the wavelength components to propagate back through the first and second angle-to-offset elements respectively, the dispersive element, and the polarizing collimator for in-coupling into a waveguide of the waveguide array.

2. The WSS of claim 1, wherein:
the dispersive element is configured to disperse the first and second sub-beams into the wavelength components in a first plane;
the first and second angle-to-offset elements are configured to focus the wavelength components of the first and second sub-beams, respectively, in the first plane; and
the first and second deflector arrays are configured to redirect the wavelength components in spaced apart planes perpendicular to the first plane.

3. The WSS of claim 2, wherein the first and second angle-to-offset elements each comprise an acylindrical lens having a non-zero optical power in the first plane, and a substantially zero optical power in a plane perpendicular to the first plane.

4. The WSS of claim 2, wherein waveguides of the waveguide array are disposed in a plane perpendicular to the first plane, wherein the polarizing collimator comprises a birefringent element optically coupled to each waveguide of the waveguide array, for angularly separating the first and second sub-beams in the first plane.

5. The WSS of claim 4, wherein the polarizing collimator further comprises a rotationally symmetric lens having a first focal length and disposed substantially one first focal length downstream of the birefringent element, for collimating the first and second sub-beams to propagate parallel to one another.

6. The WSS of claim 1, further comprising a polarization rotator in an optical path of at least one of the first or second sub-beams upstream of the dispersive element, for converting a polarization state of at least one of the first or second sub-beams such that the first and second sub-beams have a substantially same polarization state.

7. The WSS of claim 2, further comprising a prismatic beam expander for expanding the first and second sub-beams in the first plane, wherein the prismatic beam expander is disposed in an optical path of the first and second sub-beams between the polarizing collimator and the dispersive element.

8. The WSS of claim 1, wherein the dispersive element comprises first and second diffraction gratings for dispersing the first and second sub-beams, respectively, into the wavelength components, wherein the first and second diffraction gratings are disposed in different planes separated by a non-zero distance therebetween.

9. The WSS of claim 8, wherein the dispersive element further comprises first and second in-coupling prisms coupled to the first and second diffraction gratings respectively, for receiving the first and second sub-beams respectively, and for coupling the first and second sub-beams to the first and second diffraction gratings respectively.

10. The WSS of claim 9, wherein the first and second in-coupling prisms are disposed parallel one another and optically joined by an interface layer therebetween extending along parallel paths of propagation of the first and second sub-beams in the first and second in-coupling prisms respectively, such that during alignment of the WSS, a relative position of the first and second in-coupling prisms along the paths of propagation is adjustable by sliding at least one of the first or second in-coupling prism along the interface layer.

11. The WSS of claim 10, wherein an optical path of the wavelength components of the second sub-beam dispersed by the second diffraction grating comprises in sequence the second in-coupling prism, the interface layer, and the first in-coupling prism.

12. A dual grism comprising:
first and second in-coupling prisms for receiving and propagating therein first and second spaced apart sub-beams, respectively, of a light beam; and
first and second diffraction gratings coupled to the first and second in-coupling prisms respectively, for dispersing the first and second sub-beams respectively into first and second wavelength components respectively, wherein the first and second diffraction gratings are disposed in different planes separated by a non-zero distance therebetween;
wherein the first and second in-coupling prisms are disposed parallel one another and optically joined by an interface layer therebetween extending along parallel paths of propagation of the first and second sub-beams in the first and second in-coupling prisms respectively.

13. The dual grism of claim 12 wherein, during alignment of the dual grism, a relative position of the first and second in-coupling prisms along the parallel paths of propagation is adjustable by sliding at least one of the first or second in-coupling prism along the interface layer.

14. The dual grism of claim 12, wherein an optical path of the second wavelength components comprises in sequence the second in-coupling prism, the interface layer, and the first in-coupling prism; and
wherein, during alignment of the second in-coupling prism by sliding the second in-coupling prism along the interface layer, the optical path of the first wavelength components substantially does not change.

15. The dual grism of claim 14, further comprising a first out-coupling prism optically joined to the first in-coupling prism via a first layer therebetween, for out-coupling the first wavelength components from the first in-coupling prism, such that during alignment of the dual grism, a position of the first out-coupling prism is adjustable by sliding the first out-coupling prism along the first layer, for adjusting an optical path length of the first wavelength components without adjusting an optical path length of the second wavelength components.

16. The dual grism of claim 14, further comprising a second out-coupling prism optically joined to the first in-coupling prism via a second layer therebetween, for out-coupling the second wavelength components from the first in-coupling prism, such that during alignment of the dual grism, a position of the second out-coupling prism is adjustable by sliding the second out-coupling prism along the second layer, for adjusting an optical path length of the second wavelength components without adjusting an optical path length of the first wavelength components.

17. The dual grism of claim 12, wherein the first and second in-coupling prisms each comprise first to fourth conterminous faces, wherein:
the second face of the first in-coupling prism is coupled to the fourth face of the second in-coupling prism via the interface layer;
the first and second sub-beams are received at the first faces of the first and second in-coupling prisms respectively; and
the first and second diffraction gratings are coupled to the third faces of the first and second in-coupling prisms respectively.

18. A method for aligning a wavelength selective switch comprising a polarizing collimator for splitting an input light beam into polarized collimated first and second sub-beams, the method comprising:
aligning the polarizing collimator to provide the first and second sub-beams propagating along non-overlapping optical paths;
aligning a first portion of a dispersive element for dispersing the first sub-beam into first wavelength components impinging onto a first angle-to-offset element independently of alignment of the second sub-beam, for the first angle-to-offset element to focus the first wavelength components onto a first deflector array; and
aligning a second, different portion of the dispersive element for dispersing the second sub-beam into second wavelength components impinging onto a second angle-to-offset element independently of alignment of the first sub-beam, for the second angle-to-offset element to focus the second wavelength components onto a second, separate deflector array.

19. The method of claim 18, wherein:
the first and second portions of the dispersive element comprise first and second in-coupling prisms respectively for in-coupling the first and second sub-beams respectively, wherein the first and second in-coupling prisms are optically coupled to one another by an interface therebetween;
the aligning of the first portion of the dispersive element comprises aligning the first portion relative to the first angle-to-offset element; and
the aligning of the second portion of the dispersive element comprises sliding the second in-coupling prism relative to the first in-coupling prism along the interface;
wherein in operation, the second wavelength components propagate in sequence through the second in-coupling prism, the interface, and the first in-coupling prism.

20. The method of claim 19, wherein:
the first and second portions of the dispersive element comprise first and second out-coupling prisms respectively for out-coupling the first and second wavelength components, respectively, from the dispersive element, wherein the first and second out-coupling prisms are optically coupled to the first in-coupling prism via first and second layers therebetween, respectively; and
the aligning of the second portion of the dispersive element further comprises aligning the second out-coupling prism by sliding the second out-coupling prism along the second layer, for adjusting an optical path length of the second wavelength components independently of an optical path length of the first wavelength components.
